(19) United States
(12) Patent Application Publication
(10) Pub. No.: US 2011/0246946 A1
(43) Pub. Date: Oct. 6, 2011

(54) Apparatus and Method for Interacting with Embedded Objects in Mail Application

(76) Inventor: Douglas Weber, Arcadia, CA (US)

(21) Appl. No.: 12/751,936

(22) Filed: Mar. 31, 2010

(51) Int. Cl. G06F 3/048

(52) U.S. Cl. 715/838

(57) ABSTRACT

Improved techniques are disclosed for interacting with embedded objects. The embedded objects may comprise digital media content, such as or images (e.g., photos), audio items (e.g., audio files, including music or songs), or videos (e.g., movies). By generating thumbnails of embedded objects in a mail application, they can be interspersed with text and kept in context.

### BACKGROUND OF THE INVENTION

Powered by recent advances in digital media technology, there is a rapid increase in variety of different ways of interacting with digital media content, such as images (e.g., photos), audio items (e.g., audio files, including music or songs), or videos (e.g., movies). Further, today e-mail has become central to how we communicate with each other. Messages may be sent at any time and from any place.

While availability of e-mail provides many advantages, some challenges still remain. For example, interacting with media content may be limited, require too many manual steps for users, or not always be intuitive, easy or convenient for users. Thus, there is a need for improved techniques for interacting with media content.

### SUMMARY

Improved techniques are disclosed for interacting with embedded objects. The embedded objects may comprise digital media content, such as images (e.g., photos) or videos (e.g., movies). By generating thumbnails of embedded objects in a mail application, the thumbnails of the embedded objects can be interspersed with text and kept in context.

Embodiments of the invention can be implemented in numerous ways, including as a method, system, device, apparatus (including graphical user interface), or computer readable medium. Several embodiments of the invention are discussed below.

As a computer system for interacting with embedded objects in a mail application of a client device, one embodiment includes at least: an embedded object identifier for identifying embedded objects in the mail application; and a thumbnail generator for generating thumbnails of the embedded objects in the mail application so that the thumbnails can be interspersed with text and kept in context.

As a computer implemented method, one embodiment includes at least identifying embedded objects in a mail application, and generating thumbnails of the embedded objects in the mail application so that the thumbnails can be interspersed with text and kept in context.

As a computer implemented method, another embodiment includes at least generating thumbnail of embedded objects in mail application, so that the thumbnails can be interspersed with text and kept in context, and expanding at least one of the thumbnails when specific input is received.

As computer readable medium including at least computer program code for interacting with embedded objects in a mail application, one embodiment includes at least computer program code for identifying embedded objects in a mail application, and computer program code for generating thumbnails of the embedded objects in the mail application so that the thumbnails can be interspersed with text and kept in context.

As a computer readable medium including at least computer program code stored therein for interacting with embedded objects in a mail application, one embodiment can include at least computer program code for identifying embedded objects in an electronic mail message made available by a mail application. The electronic mail message can include at least text and the embedded objects. The embodiment can also include computer program code for producing reduced-area representations of the identified embedded objects in the mail application. Still further, the embodiment can include computer program code for presenting one or more of the reduced-area representations of the identified embedded objects and at least a portion of the text if the electronic mail message is to be presented via the mail application.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a system for interacting with embedded objects, according to one embodiment.

FIG. 2 is a flow diagram of a process for interacting with embedded objects, according to one embodiment.

FIG. 3 is a flow diagram of another process for interacting with embedded objects, according to one embodiment.

FIGS. 4A-4D show mail application displays, illustrating one embodiment.

FIG. 5 shows another mail application display, illustrating one embodiment.

FIG. 6 shows yet another mail application display, illustrating one embodiment.

### DETAILED DESCRIPTION OF EMBODIMENTS OF THE INVENTION

Improved techniques are disclosed for interacting with embedded objects. The embedded objects may comprise digital media content, such as images (e.g., photos) or videos (e.g., movies). The improved techniques disclosed herein may be used for interacting with embedded objects of different types or various combinations. By generating thumbnails of embedded objects in a mail application, the thumbnails of the embedded objects can be interspersed with text and kept in context.

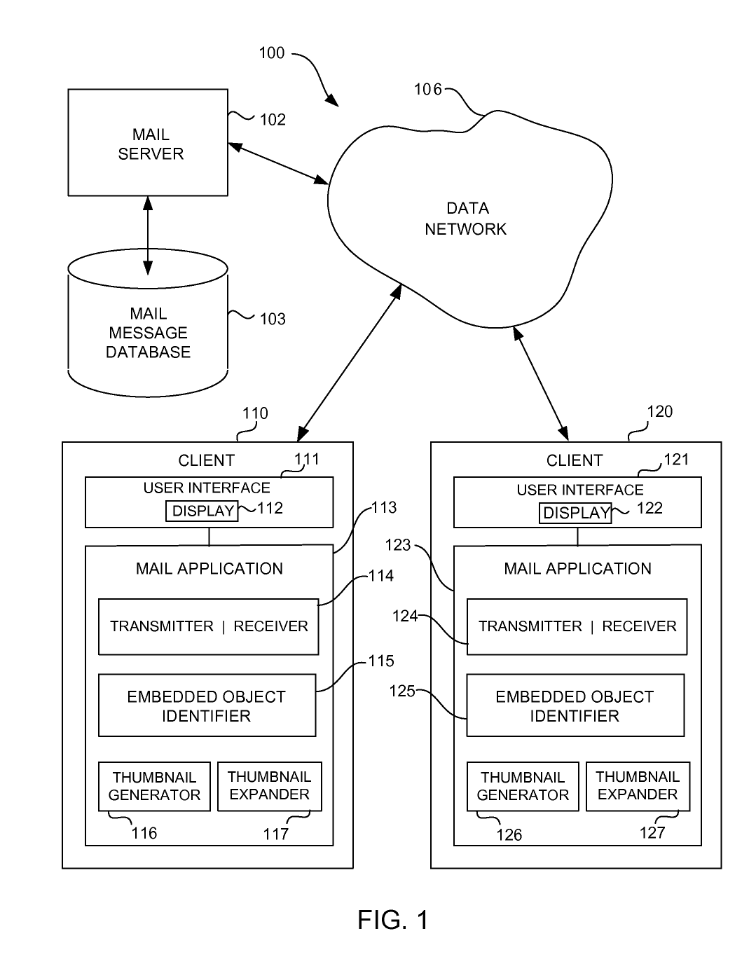

Embodiments of the invention are discussed below with reference to FIGS. 1-6. However, those skilled in the art will readily appreciate that the detailed description given herein with respect to these figures is for explanatory purposes, as the invention extends beyond these limited embodiments.

FIG. 1 is a block diagram of a system 100 for interacting with embedded objects, according to one embodiment. A mail server 102 may be coupled to a mail message database 103 for managing electronic mail messages, and further may be coupled through a data network 106 to a plurality of client devices 110, 120.

Each of the client devices 110, 120 shown in FIG. 1 may comprise respective user interfaces 111, 121 having displays 112, 122, and may further comprise a respective mail application 113, 123 running on each of the client devices 110, 120. As shown in FIG. 1, each of the client devices 110, 120 is operatively coupled with the mail server 102 through the data network 106 for sending and/or receiving mail between the client devices 110, 120 using the client mail applications 113, 123. The client mail applications 113, 123 operate on the client devices 110, 120 and can facilitate presentation of electronic mail messages on the display 112, 122 and also review and management of such electronic mail messages.

As will be discussed in greater detail subsequently herein, each of the mail applications 113, 123 may comprise additional modules such as respective transmitter/receiver modules 114, 124, respective embedded object identifier modules 115, 125 for identifying embedded objects in each of the mail applications 113, 123, and respective thumbnail generator modules 116, 126 for generating thumbnails of the embedded objects in each of the mail applications 113, 123 so that they can be interspersed with text and kept in context.

Each of the client devices 110, 120 shown in FIG. 1 may employ the respective user interfaces 111, 121 for receiving specific input instructing the respective thumbnail generator modules 116, 126 to generate thumbnails of the embedded objects in the respective mail applications 113, 123. Each of the displays 112, 122 may be employed for displaying the thumbnails of the embedded objects interspersed with text in the respective mail applications 113, 123. Each of the client devices 110, 120 shown in FIG. 1 may employ the transmitter/receiver modules 114, 124, for transmitting the thumbnails of the embedded objects interspersed with text over the data network 106, and for receiving the thumbnails of the embedded objects interspersed with text over the data network 106.

Each of the mail applications 113, 123 shown in FIG. 1 may further comprise respective thumbnail expander modules 117, 127 for expanding the thumbnails in each of the mail applications 113, 123. Each of the client devices 110, 120 shown in FIG. 1 may employ the respective user interfaces 111, 121 for receiving specific input instructing the thumbnail expander modules 117, 127 to expand the thumbnails in the respective mail applications 113, 123.

In discussions of the client devices 110, 120, their user interfaces 111, 121, their mail applications 113, 123 and the various modules of the mail applications, suitable control logics may be used for implementation. It should be understood that “logic”, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software or software components. Where multiple logical logics are described, it may be possible to incorporate the multiple logical logics into one physical logic.

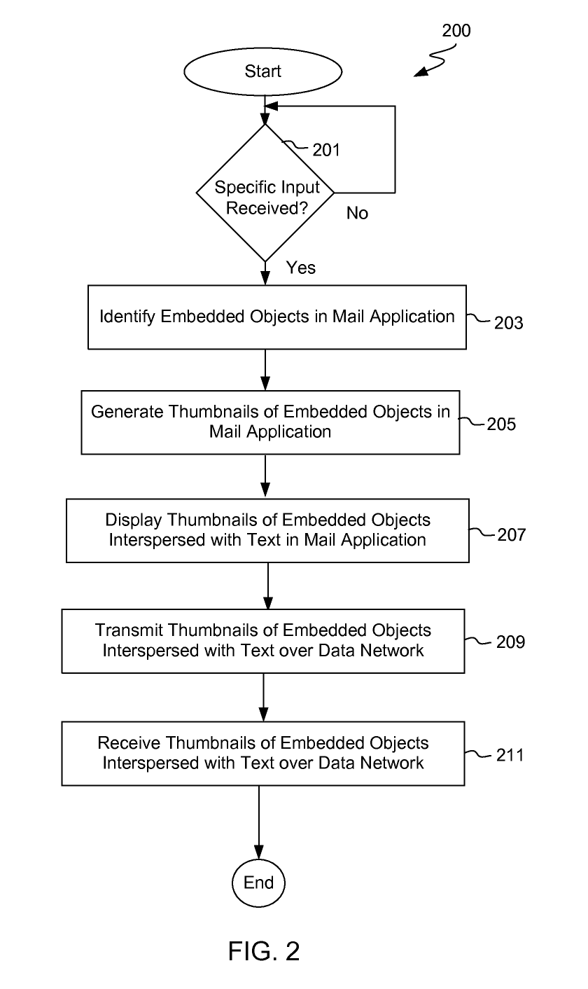

FIG. 2 is a flow diagram of a process 200 for interacting with embedded objects, according to one embodiment. The process 200 may begin with decision 201 that determines whether specific input has been received, directing generation of thumbnails of embedded objects in an electronic mail message provided by a mail application. When the decision 201 determines that specific input has not been received, and that thumbnails of embedded objects are not to be generated at this time, then the process 200 awaits the specific input to generate thumbnails. In other words, the process 200 can be invoked whenever the specific input is received. Typically, a user of the client device would interact with the client device (e.g., the mail application module 113) to provide specific input, initiating a request to generate thumbnails.

In any case, once the decision 201 determines that thumbnails are to be generated, embedded objects in the mail application may be identified 203 and thumbnails of the embedded objects may be generated 205. For example, tags identifying the embedded objects may be read. Thumbnails of the embedded objects in the mail application may be generated so that they can be interspersed with text and kept in context.

The process 200 may continue with displaying 207 the thumbnails of the embedded objects interspersed with text. One mail application may transmit 209 the thumbnails of the embedded objects interspersed with text over the data network. Another mail application may receive 211 the thumbnails of the embedded objects interspersed with text over the data network. Accordingly, each of the client devices is operatively coupled through the data network for sending and/or receiving mail between the client devices using the clients' mail applications. The process 200 can then end.

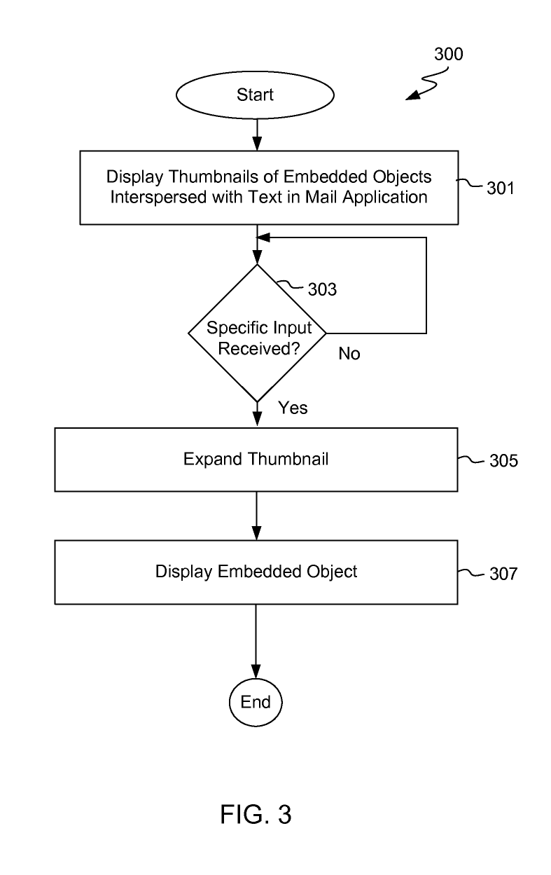

FIG. 3 is a flow diagram of another process 300 for interacting with embedded objects, according to one embodiment. The process 300 may begin with display 301 of the thumbnails of the embedded objects, interspersed with text, of an electronic mail message provided by the mail application operating on a client device.

The process 300 may continue with decision 303 that determines whether specific input has been received, directing thumbnail expansion. When the decision 303 determines that specific input has not been received, and that thumbnail expansion is not desired at this time, then the process 300 awaits the specific input directing thumbnail expansion. In other words, the process 300 can be invoked whenever the specific input is received. Typically, a user of the client device would interact with the client device (e.g., the mail application module 113) to provide specific input, initiating a request for thumbnail expansion.

In any case, once the decision 303 determines that thumbnail expansion is desired, the process 300 can proceed. Thumbnail can be expanded 305 and embedded object can be displayed 307 at the client device. The process 300 can then end.

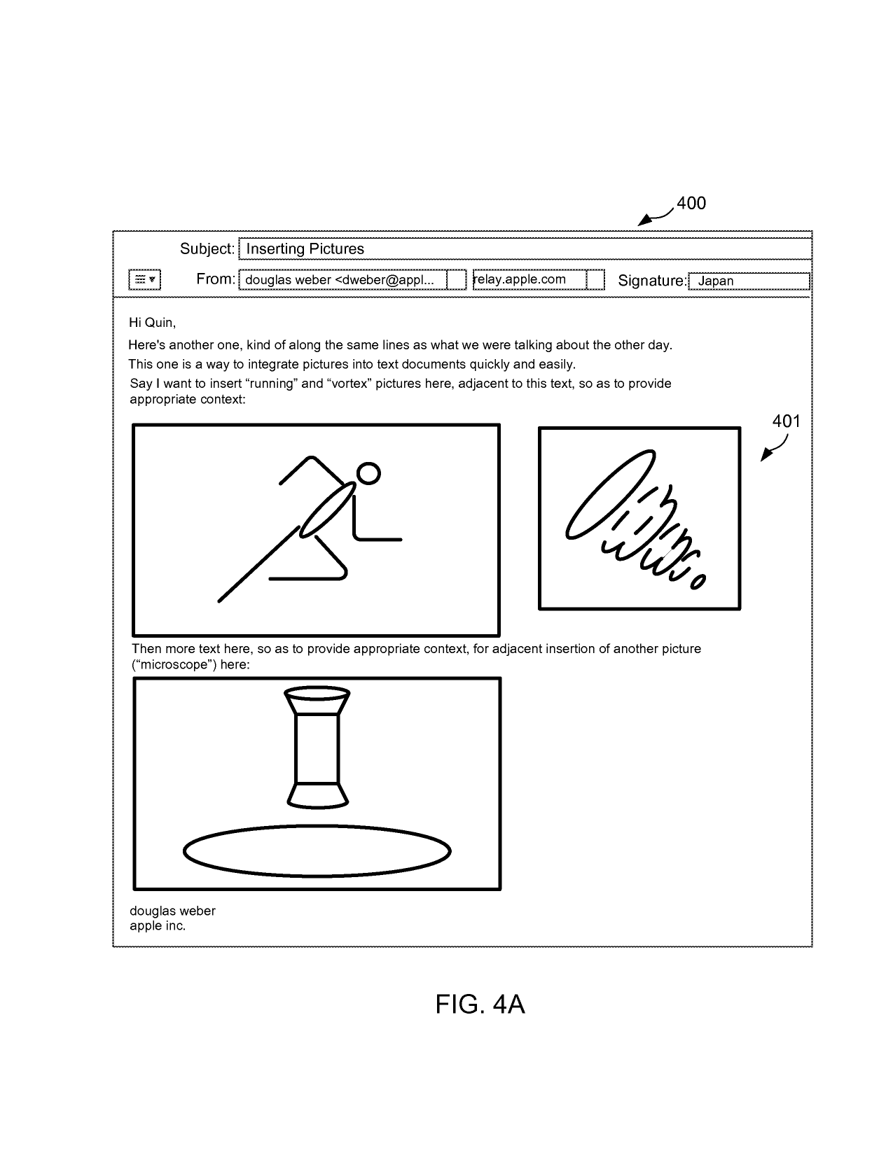

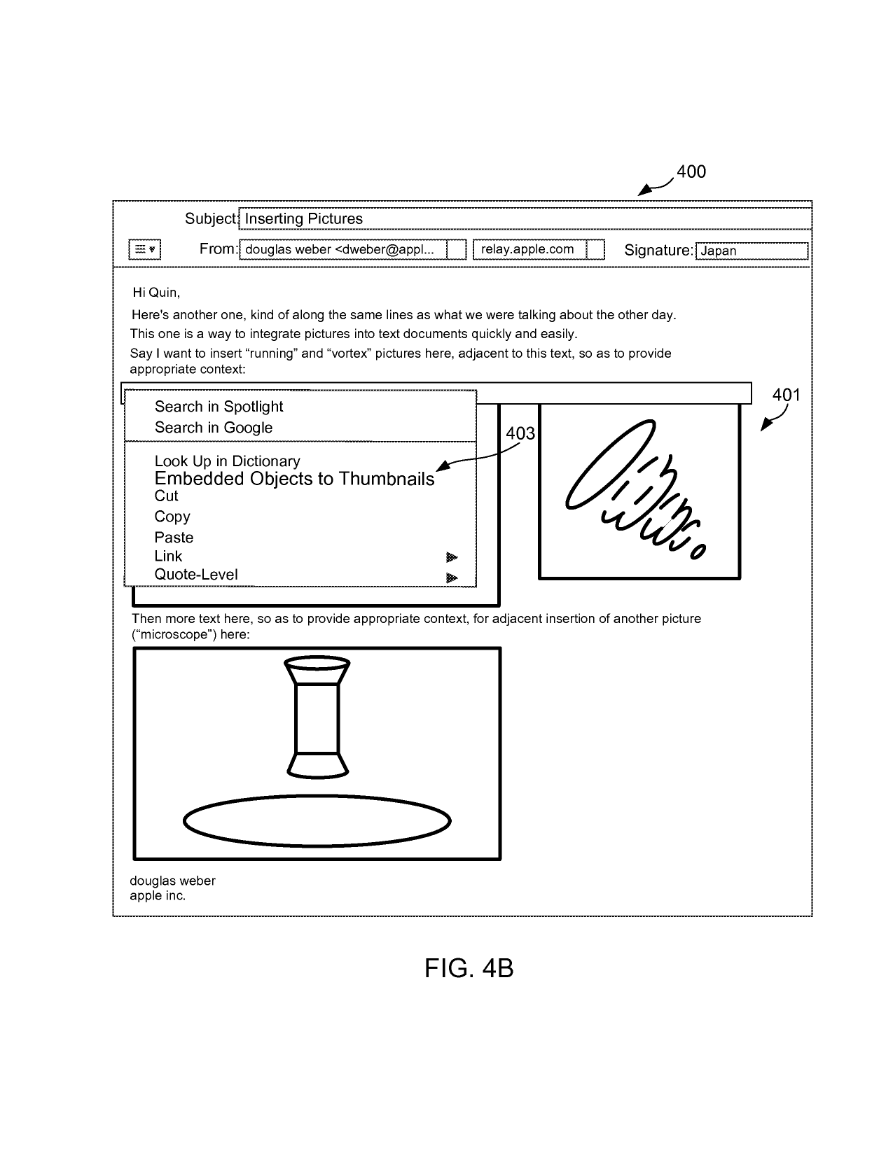

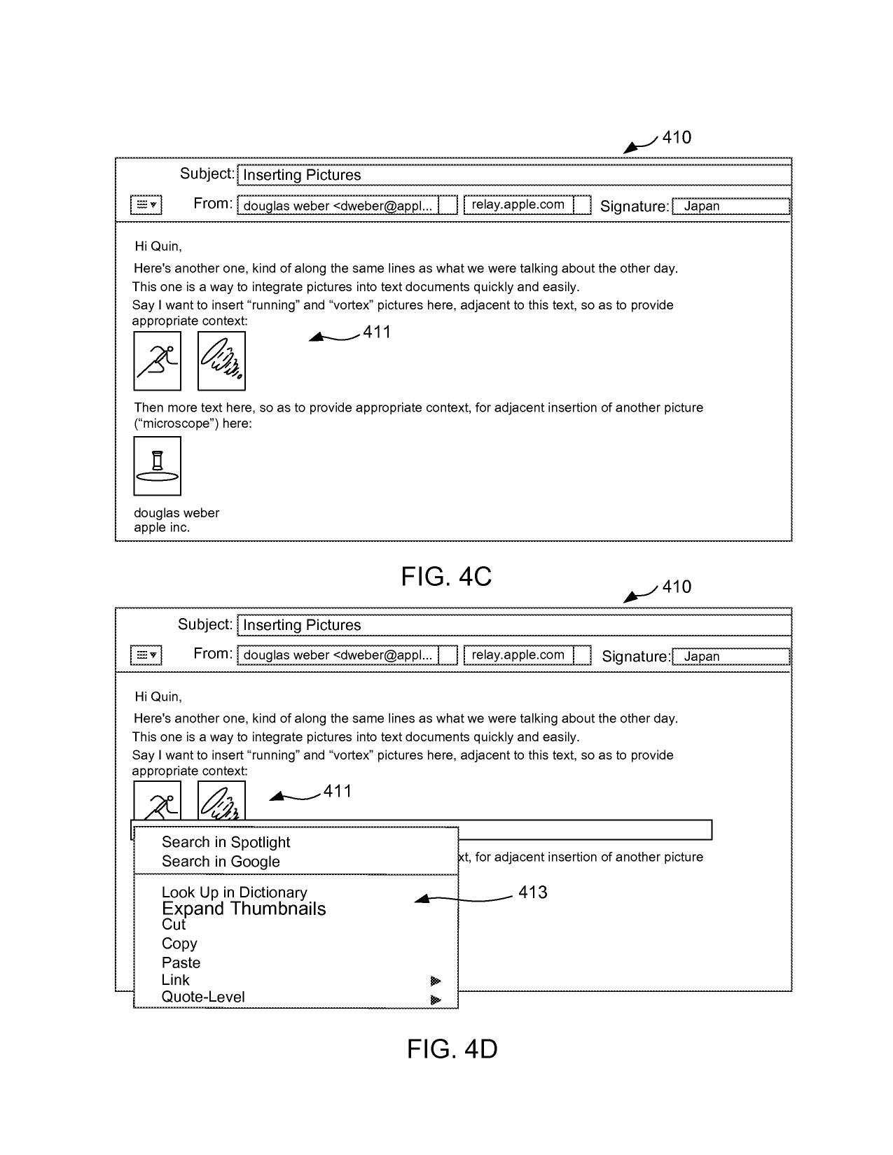

FIGS. 4A-4D show mail application displays, illustrating one embodiment. In a mail application display 400 shown in FIG. 4A, an electronic mail message has multiple embedded graphics objects 401 shown full (large) scale and inserted inline with text. Full scale display of the multiple embedded graphics objects 401 may provide some benefits, in that full detail of each of the embedded graphics 401 may be perceived by a user. However, from a point of view of the user, full scale size of the multiple embedded graphics objects 401 may make them seem to predominate over the text, and accordingly may evoke a feeling of viewing almost entirely embedded graphics objects. As valuable as the full scale embedded graphics objects 401 may be, a user may feel distracted by the size and number of the embedded graphics objects 401, and may feel like they “get in the way” when reading the text.

In the mail application display 400 shown in FIG. 4B, multiple embedded graphics objects 401 are again shown full scale and inserted inline with text. However, as shown in FIG. 4B, specific input can be received by the mail application, directing generation of thumbnails of embedded objects in the mail application. For example, through the user interface, the user of the mail application can interact with the embedded objects 401 in the mail application display 400, so as to provide specific input by selecting a menu option 403 (“Convert to Thumbnails”) and thereby initiating a request to generate thumbnail of the embedded objects 401. The user interaction can take may forms depending on implementation.

In any case, when such specific input is received to request the thumbnails, the thumbnails of the embedded objects can be generated. The mail application display 410 of FIG. 4C shows thumbnails 411 of the embedded objects in the mail application, which can be interspersed with text and kept in context. Of course, display of the thumbnails 411 may not provide the user with as full a perception of detail, as provided by the previously discussed full scale embedded graphics objects. However, the thumbnails 411 can advantageously retain recognizability in their representation of the embedded objects, and may provide other benefits as well.

In particular, from a point of view of the user, a scaled down size of the thumbnails 411 may help to avoid any feeling of their predominating over the text. Accordingly the thumbnails 411 may evoke a beneficial balanced feeling of viewing thumbnails suitable balanced in scale relative to text. Rather than feeling distracted by the size and number of full scale embedded graphics objects (and feeling like they “get in the way”, when reading the text), thumbnails 411 of the embedded objects can be interspersed with text, and kept in context while smoothly reading the text.

In the mail application display 410 shown in FIG. 4D, thumbnails 411 of the embedded objects in the mail application are again shown interspersed with text and kept in context. However, as shown in FIG. 4D, specific input can be received by the mail application, directing expansion of the thumbnails of embedded objects in the mail application. For example, through the user interface, the user of the mail application can provide specific input by selecting a menu option 413 (“Expand Thumbnails”) and thereby initiating a request to expand thumbnail of the embedded objects 401.

In any case, when such specific input is received to request expansion of the thumbnails, the thumbnails of the embedded objects can be expanded. As the thumbnails are expanded, the mail application display 410 of thumbnails 411 shown in FIG. 4D can regress to the previously discussed mail application display 400 of full scale embedded graphics objects 401 shown in FIG. 4A.

From the foregoing discussion the FIGS. 4A-4D mail application displays, it should be understood that a user may provide specific inputs (for example, through menu selections) so as to switch quickly and easily between thumbnails interspersed with text (for smooth reading of the text), and full scale embedded graphics objects (for a relatively higher detail display of the embedded graphics objects). The specific inputs, however, can vary depending on the programming implementation and the client device. For example, the specific inputs can be provided through one or more of: menu selections, cursor position, pointing device (e.g., mouse, touchpad) actions, gestures, audio commands, etc.).

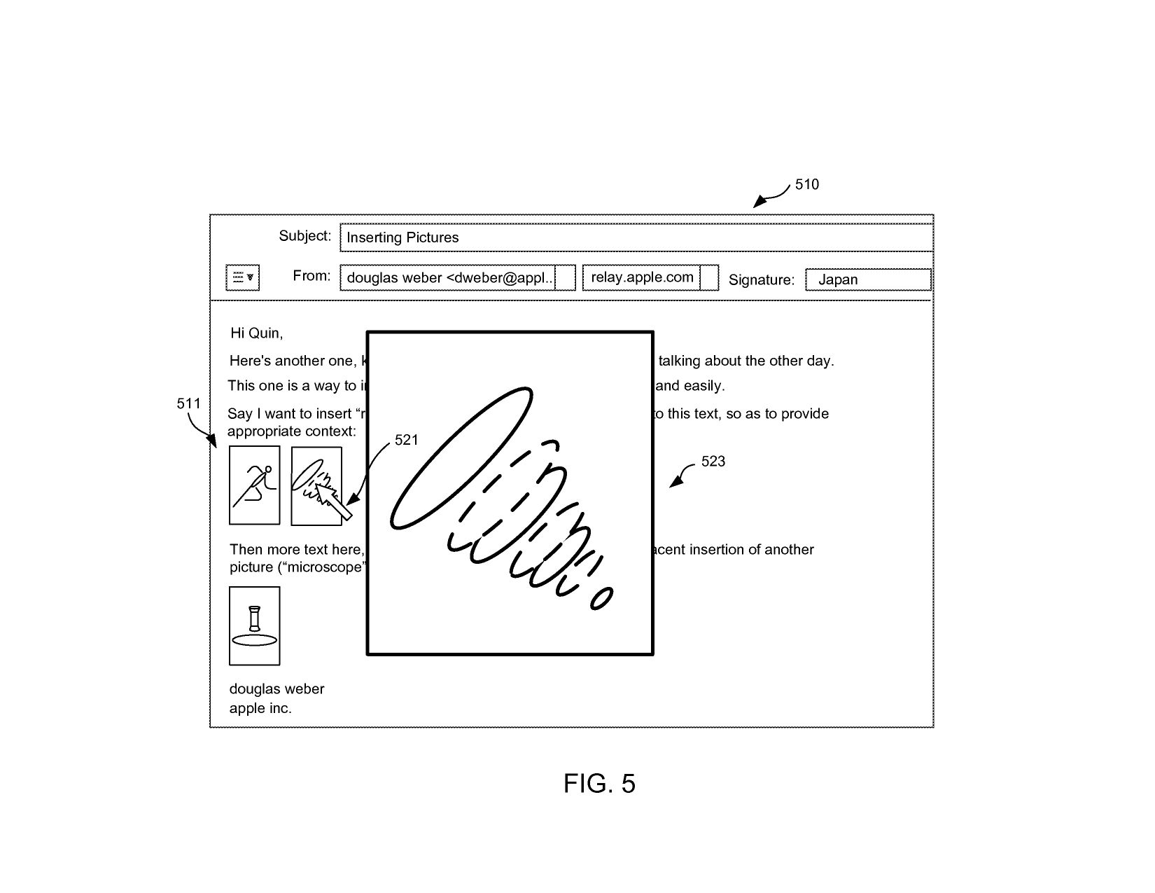

FIG. 5 shows another mail application display 510, illustrating one embodiment. Thumbnails 511 of the embedded objects in the mail application are again shown interspersed with text and kept in context. Specific input can be received by the mail application, selectively directing expansion of any one of the thumbnails of embedded objects in the mail application. For example, through the user interface, the user of the mail application can selectively direct expansion of one of the thumbnails using a cursor arrow 521 and thereby initiate a request to expand the selected thumbnail. In response, one of the thumbnails may be expanded to show a corresponding full scale embedded graphic object 522 adjacent to the cursor arrow 521.

The cursor arrow 521 may be employed in various alternative ways to selective direct expansion of one of the thumbnails. In one mode, one of the thumbnails may be expanded automatically, simply by placing the cursor arrow 521 over the selected thumbnail. In another mode, after a user places the cursor arrow over the selected thumbnail, the user clicks a mouse button of the user interface a preferred number of times, so as to effect expansion of the selected thumbnail.

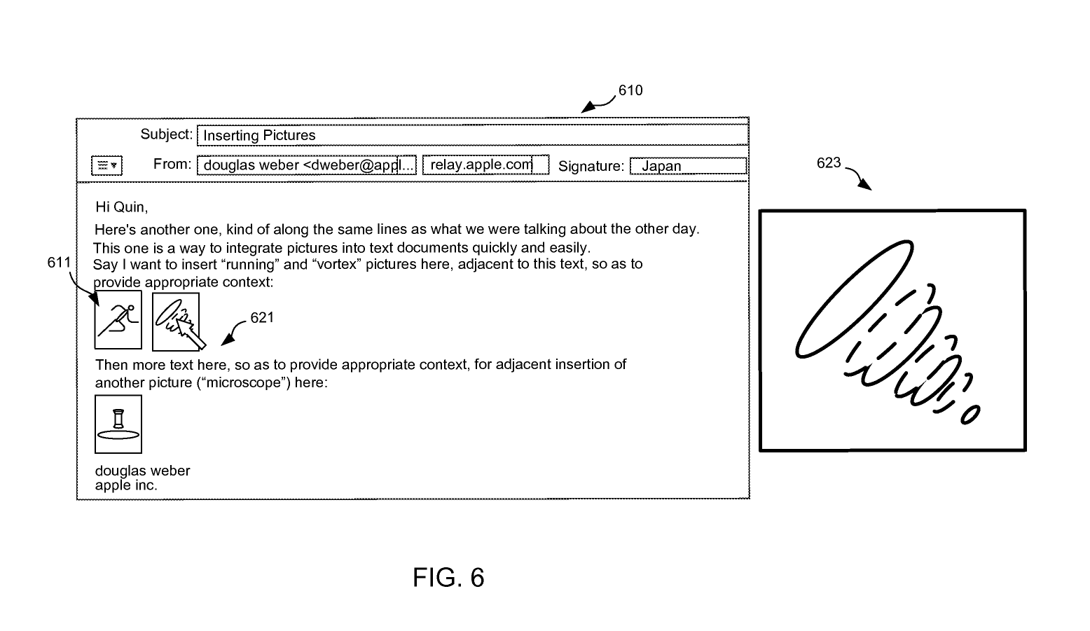

FIG. 6 shows yet another mail application display 610, illustrating one embodiment. Thumbnails 611 of the embedded objects in the mail application are again shown interspersed with text and kept in context. Once again, specific input can be received by the mail application, selectively directing expansion of any one of the thumbnails of embedded objects in the mail application. The user of the mail application can selectively direct expansion of one of the thumbnails using a cursor arrow 621 and thereby initiate a request to expand the selected thumbnail. In response, one of the thumbnails may be expanded to show a corresponding full scale embedded graphic object 622 adjacent (or proximate) to the display of the mail application.

The mail application discussed herein can pertain to an application program that provide for receiving, sending and managing electronic mail messages. The mail application can include applications that include or have access to mail capabilities, e.g., dedicated electronic mail applications, integrated programs including electronic mail functionality, operating system with mail capabilities, web browser with access to mail capabilities, etc. Although embodiment of the invention are discussed in context of a mail application, in other embodiments there need not be a mail application.

Also, although embodiments of the invention were primarily discussed herein with reference to electronic mail messages, it should be noted that embodiment of the invention can also operate, more generally, on electronic documents. Typically, the electronic documents would include at least one graphical item (e.g., image, table, drawings, etc.) as well as other non-graphical content (e.g., text).

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The advantages of the invention are numerous. Different aspects, embodiments or implementations may yield one or more of the following advantages. One advantage of the invention is that generating thumbnail of embedded objects in mail application, so that they can be interspersed with text and kept in context, may be perceived by a user as convenient, intuitive or user-friendly. Another advantage of the invention is that such thumbnail can retain recognizability in their representation of the embedded objects. Another advantage of the invention may be automated thumbnail generation and/or expansion. Another advantage of the invention may be thumbnails evoking a beneficial balanced feeling, when viewing thumbnails suitable balanced in scale relative to text. Another advantage of the invention may be that thumbnails of the embedded objects can be interspersed with text, and kept in context while smoothly reading the text.

The various aspects, features, embodiments or implementations described above can be used alone or in various combinations.

The many features and advantages of embodiments of the invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A system arranged for interacting with embedded objects in a mail application operating on a client device, the system comprising:
an embedded object identifier for identifying embedded objects in the mail application; and
a thumbnail generator for generating thumbnails of the embedded objects in the mail application so that the thumbnails of the embedded images can be interspersed with text and kept in context.

2. A system as recited in claim 1 further comprising a user interface for receiving specific input instructing the thumbnail generator to generate the thumbnails of the embedded objects in the mail application.

3. A system as recited in claim 1 further comprising a display device for displaying the thumbnails of the embedded objects interspersed with text in the mail application.

4. A system as recited in claim 1 further comprising a transmitter for transmitting the thumbnails of the embedded objects interspersed with text over a data network.

5. A system as recited in claim 1 further comprising a receiver for receiving the thumbnails of the embedded objects interspersed with text over a data network.

6. A system as recited in claim 1, wherein the embedded objects comprise digital pictures.

7. A system as recited in claim 1, wherein the embedded objects comprise video clips.

8. A system as recited in claim 1, further comprising a thumbnail expander for expanding the thumbnails in the mail application.

9. A system as recited in claim 8, further comprising a user interface for receiving specific input for instructing the thumbnail expander to expand at least one of the thumbnails in the mail application.

10. A computer implemented method comprising:
identifying embedded objects in a mail application; and
generating thumbnails of the embedded objects in the mail application so that the thumbnails of the embedded objects can be interspersed with text and kept in context.

11. A computer implemented method as recited in claim 10, wherein the generating thumbnails comprises generating thumbnails when specific input is received.

12. A computer implemented method as recited in claim 10, further comprising displaying the thumbnails of the embedded objects interspersed with text in the mail application.

13. A computer implemented method as recited in claim 10, further comprising the mail application transmitting the thumbnails of the embedded objects interspersed with text over a data network.

14. A computer implemented method as recited in claim 10, further comprising the mail application receiving the thumbnails of the embedded objects interspersed with text over a data network.

15. A computer implemented method as recited in claim 10, wherein the embedded objects comprise digital pictures.

16. A computer implemented method as recited in claim 10, wherein the embedded objects comprise video clips.

17. A computer implemented method as recited in claim 10, further comprising expanding the thumbnails in the mail application.

18. A computer implemented method as recited in claim 10, further comprising expanding the thumbnails in the mail application when specific input is received.

19. A computer implemented method comprising:
generating thumbnail of embedded objects in mail application, so that they can be interspersed with text and kept in context; and
expanding thumbnail when a specific input is received.

20. A computer readable medium including at least computer program code stored therein for interacting with embedded objects in a mail application, said computer readable medium comprising:
computer program code for identifying embedded objects in an electronic mail message made available by a mail application, the electronic mail message including at least text and the embedded objects;
computer program code for producing reduced-area representations of the identified embedded objects in the mail application; and
computer program code for presenting one or more of the reduced-area representations of the identified embedded objects and at least a portion of the text if the electronic mail message is to be presented via the mail application.

21. A computer readable medium as recited in claim 20, wherein the computer code for presenting the one or more of the reduced area representations and the at least a portion of the text comprises computer program code for presenting the one or more of the reduced-area representations, with the one or more of the reduced-area representations being interspersed with the text of the electronic mail message if the electronic mail message is to be presented.

22. A computer readable medium as recited in claim 21, wherein the one or more of the reduced-area representations are presented are presented proximate to one or more portions of the text of the electronic mail message corresponding thereto.
